(19) United States
(12) Patent Application Publication
(10) Pub. No.: US 2016/0248362 A1
(43) Pub. Date: Aug. 25, 2016

(54) Hybrid Soft Switching for Current Regulation in Switched Reluctance Machines

(71) Applicant: CATERPILLAR INC., Peoria, IL (US)

(72) Inventors: Carlos Nino Baron, Edwards, IL (US); Ernesto Inoa, Dunlap, IL (US); Jackson Wai, Dunlap, IL (US); Jesse Gerdes, Dunlap, IL (US); Ahmed Khalil, Peoria, IL (US)

(73) Assignee: CATERPILLAR INC., Peoria, IL (US)

(21) Appl. No.: 14/626,635

(22) Filed: Feb. 19, 2015

(51) Int. Cl. H02P 25/08

(52) U.S. Cl. CPC H02P 25/08

(57) ABSTRACT

A method of regulating a phase current of an electric motor is provided. The method may include selectively enabling one or more switches of each phase of the electric motor according to one of at least a soft chopping motoring routine and a soft chopping generating routine, monitoring the phase current relative to a first hysteresis band, controlling the switches according to the soft chopping motoring routine when the phase current exceeds the first hysteresis band while operating according to the soft chopping generating routine, and controlling the switches according to the soft chopping generating routine when the phase current exceeds the first hysteresis band while operating according to the soft chopping motoring routine.

### TECHNICAL FIELD

The present disclosure relates generally to electric generators and electric motors, and more particularly, to systems and methods of regulating phase current in switched reluctance machines.

### BACKGROUND

Electric generators are often used to convert mechanical power received from a primary power source, such as a combustion engine, into electrical power for powering one or more loads of a work machine. Electric motors can be used to convert electrical power within a common bus or storage device into mechanical power, such as rotational power for driving wheels, tracks or other traction devices. Furthermore, electric motors can also be used to convert mechanical power received through traction devices, such as during regenerative braking, into electrical power for storage or use by other loads. Among the various types of electric machines available, switched reluctance machines have received great interest for being robust, cost-effective, and generally more efficient. While various systems and methods for controlling switched reluctance machines are currently available, there is still room for improvement.

Typical control schemes for switched reluctance machines may involve operating two switches of each phase of the stator in one of two general operating modes, for example, single pulse and current regulation modes of operation. Single pulse modes are used for higher operating speeds, while current regulation modes are used for nominal or lower operating speeds. As disclosed in U.S. Pat. No. 6,922,036 (“Ehsani”), for example, current regulation modes for nominal operating speeds may be operated by hard chopping current to the two switches of each phase, while current regulation modes for relatively low operating speeds may be operated by soft chopping current to the two switches of each phase.

Hard chopping is provided by simultaneously opening and closing both switches of each phase at the required frequency, whereas soft chopping is provided by holding one of the switches in either the opened or closed position while selectively switching the remaining switch at the required frequency. Operating switches according to hard chopping routines at low operating speeds or during regenerative braking may produce phase currents that are more reliably within the desired current band. However, this is achieved at the cost of high switching frequencies and thermal stress on the converter circuit, which further limit the amount of time hard chopping can be used. Applying soft chopping routines exerts less stress on the converter circuit, but the resulting phase currents do not reside within the desired current band as consistently as with hard chopping routines.

It should be appreciated that the solution of any particular problem is not a limitation on the scope of this disclosure or of the attached claims except to the extent expressly noted. Additionally, this background section discusses observations made by the inventors; the inclusion of any observation in this section is not an indication that the observation represents known prior art except that the contents of the indicated patent represent a publication. With respect to the identified patent, the foregoing summary thereof is not intended to alter or supplement the prior art document itself; any discrepancy or difference should be resolved by reference to the document itself.

### SUMMARY OF THE DISCLOSURE

In one aspect of the present disclosure, a method of regulating a phase current of an electric motor is provided. The method may include selectively enabling one or more switches of each phase of the electric motor according to one of at least a soft chopping motoring routine and a soft chopping generating routine, monitoring the phase current relative to a first hysteresis band, controlling the switches according to the soft chopping motoring routine when the phase current exceeds the first hysteresis band while operating according to the soft chopping generating routine, and controlling the switches according to the soft chopping generating routine when the phase current exceeds the first hysteresis band while operating according to the soft chopping motoring routine.

In another aspect of the present disclosure, a control system for regulating a phase current of an electric motor is provided. The control system may include a converter circuit operatively coupled to a stator of the electric motor and including one or more switches coupled to each phase of the stator, and a controller in communication with each of the electric motor and the converter circuit. The controller may be configured to enable the switches of each phase of the stator according to one of at least a soft chopping motoring routine and a soft chopping generating routine, monitor the phase current relative to each of a first hysteresis band and a second hysteresis band, control the switches according to the soft chopping motoring routine when the phase current exceeds at least the first hysteresis band while operating according to the soft chopping generating routine, and control the switches according to the soft chopping generating routine when the phase current exceeds at least the first hysteresis band while operating according to the soft chopping motoring routine.

In yet another aspect of the present disclosure, an electric drive is provided. The electric drive may include an electric motor having a rotor and a stator and a plurality of phases, a converter circuit in communication with the electric motor and including at least a first switch and a second switch coupled to each phase, and a controller in communication with each of the electric motor and the converter circuit. The controller may be configured to monitor the phase current relative to a first hysteresis band, control the first switch and the second switch according to the soft chopping motoring routine when the phase current exceeds the first hysteresis band while operating according to the soft chopping generating routine, and control the first switch and the second switch according to the soft chopping generating routine when the phase current exceeds the first hysteresis band while operating according to the soft chopping motoring routine.

These and other aspects and features will become more readily apparent upon reading the following detailed description when taken in conjunction with the accompanying drawings. In addition, although various features are disclosed in relation to specific exemplary embodiments, it is understood that the various features may be combined with each other, or used alone, with any of the various exemplary embodiments without departing from the scope of the disclosure.

### BRIEF DESCRIPTION OF THE DRAWINGS

FIG. 1 is a diagrammatic view of one exemplary machine having an electric drive constructed in accordance with the teachings of the present disclosure;

FIG. 2 is a schematic view of one exemplary control system for an electric drive having a switched reluctance generator;

FIG. 3 is a schematic view of one exemplary control system for an electric drive having a switched reluctance motor;

FIG. 4 is a flowchart of one exemplary method of controlling a switched reluctance machine;

FIG. 5 is a graphical view of operating a switched reluctance machine using a hard chopping routine;

FIG. 6 is a graphical view of operating a switched reluctance machine using a soft chopping generating routine;

FIG. 7 is a graphical view of operating a switched reluctance machine using a soft chopping motoring routine;

FIG. 8 is a graphical view of operating a switched reluctance machine using a hybrid soft chopping routine;

FIG. 9 is a flowchart of one exemplary method of controlling a switched reluctance machine using a hybrid soft chopping routine;

FIG. 10 is a graphical view of operating a switched reluctance machine using a hybrid soft chopping routine; and

FIG. 11 is a graphical view of first and second hysteresis bands used for controlling a switched reluctance machine.

While the present disclosure is susceptible to various modifications and alternative constructions, certain illustrative embodiments thereof will be shown and described below in detail. The disclosure is not limited to the specific embodiments disclosed, but instead includes all modifications, alternative constructions, and equivalents thereof.

### DETAILED DESCRIPTION

Reference will now be made in detail to specific embodiments or features, examples of which are illustrated in the accompanying drawings. Generally, corresponding reference numbers will be used throughout the drawings to refer to the same or corresponding parts.

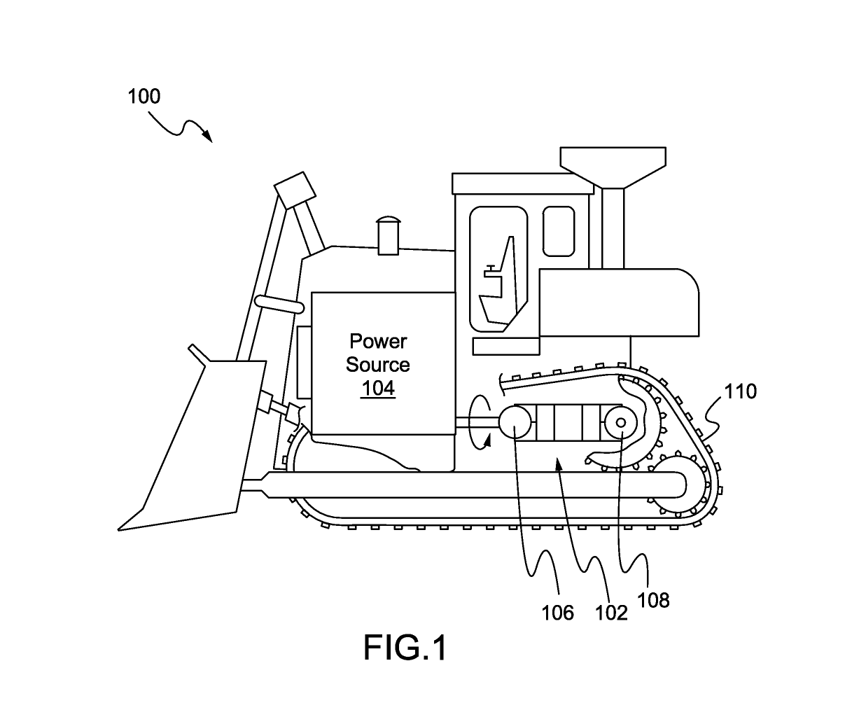

FIG. 1 illustrates one exemplary embodiment of a work machine 100 with an electric drive 102 for generating electrical power from mechanical power or for generating mechanical power from electrical power. As shown, the work machine 100 includes a power source 104 that is mechanically coupled to an electric generator 106. The electric generator 106 may convert mechanical power supplied by the power source 104 into electrical power to be used by the electric drive 102. The electric drive 102 may also include an electric motor 108 that is mechanically coupled to one or more traction devices 110 of the work machine 100. The electric motor 108 may convert electrical power supplied by the electric drive 102 into mechanical power for causing movement of the work machine 100 via the traction devices 110. In certain operating modes, such as during regenerative braking, the electric motor 108 may convert mechanical rotations received through the traction devices 110 into electrical power to be stored and/or used by the electric drive 102.

The power source 104 of FIG. 1 may include, for example, a combustion engine, such as a diesel engine, a gasoline engine, a natural gas engine, or the like. The work machine 100 may also be implemented using other types of power sources, such as batteries, fuel cells, and the like. The work machine 100 may be used in mobile applications for performing particular types of operations associated with an industry, such as mining, construction, farming, transportation, or any other suitable industry known in the art. The work machine 100 may include, for example, an earth moving machine, a marine vessel, an aircraft, a tractor, an off-road truck, an on-highway passenger vehicle, or the like. Furthermore, while the work machine 100 of FIG. 1 may be illustrated as being mobile, the work machine 100 may also be used to generate power in conjunction with stationary applications having, for instance, windmills, hydro-electric dams, or any other suitable means as a power source.

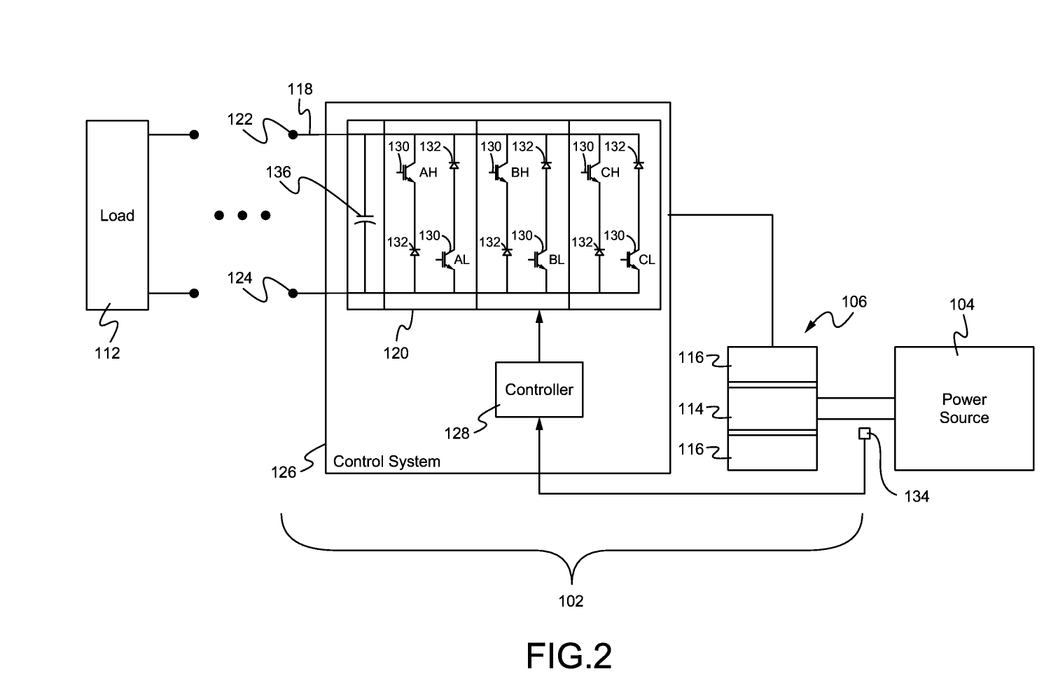

FIG. 2 schematically illustrates one exemplary electric drive 102 that can be used to communicate power between the power source 104 and one or more loads 112. The electric generator 106 of the electric drive 102 in FIG. 2 may be a switched reluctance generator, or the like, that is configured to produce electrical power in response to rotational input from the power source 104 and communicate the electrical power to the one or more loads 112 of the work machine 100. The loads 112 may include, for example, fractions motors for causing motion of the machine 100, pumps or actuators for operating machine tools, and any other electrically driven device or component associated with the work machine 100. As shown, the electric generator 106 includes a rotor 114 that is rotatably disposed within a fixed stator 116. The rotor 114 may be coupled to an output of the power source 104. The stator 116 may be electrically coupled to a common bus 118 of the electric drive 102 via a converter circuit 120.

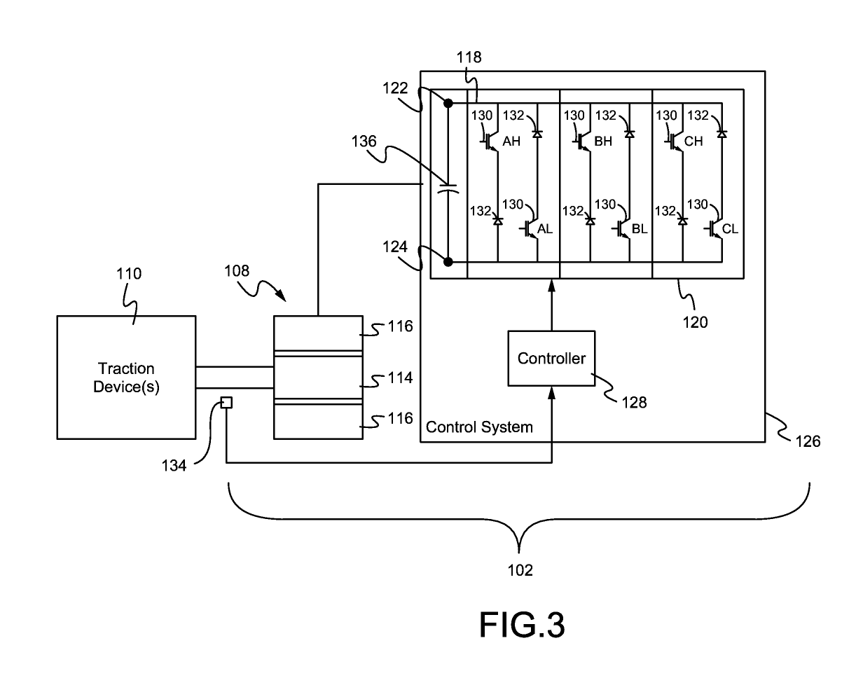

FIG. 3 schematically illustrates one exemplary electric drive 102 which communicates power between the converter circuit 120 and the electric motor 108. The electric motor 108 of the electric drive 102 may be a switched reluctance motor, or any other comparable motor capable of mechanically driving one or more traction devices 110 of the work machine 100 in response to electrical power received from the converter circuit 120. During regenerative braking modes of operation, or other low speed generating modes, the electric motor 108 may also generate and supply electrical power to the converter circuit 120 in response to rotational or otherwise mechanical input received from the traction devices 110. The electric motor 108 also includes a rotor 114 that is rotatably disposed within a fixed stator 116. The rotor 114 may be mechanically coupled to one or more of the traction devices 110, and the stator 116 may be electrically coupled to the converter circuit 120 via the common bus 118 of the electric drive 102.

Generally, during a generating mode of operation, the rotor 114 is mechanically rotated within the stator 116, which induces electrical current within the stator 116 that is further supplied to the converter circuit 120. The converter circuit 120 may in turn convert the electrical signals into an appropriate direct current (DC) voltage for distribution to any of the loads 112 of the work machine 100. During a motoring mode of operation, the rotor 114 is caused to rotate in response to electrical signals that are supplied to the stator 116 from the common bus 118. The common bus 118 may include a positive bus line 122 and a ground or negative bus line 124 across which a common DC bus voltage may be communicated to one or more loads 112 of the work machine 100. For instance, the converter circuit 120 may provide a DC signal to be transmitted through one or more rectifier circuits of the common bus 118 where the DC voltage may be converted into the appropriate alternating current (AC) signals for driving the electric motor 108 or any other load 112 requiring an AC supply voltage. The common bus 118 may also communicate the common DC voltage to other loads 112 of the work machine 100, such as to electrically driven pumps, fans, and the like.

The electric drive 104 of FIGS. 2 and 3 additionally includes a control system 126 for controlling the electric generator 106 and/or the electric motor 108. As shown, the control system 126 provides a controller 128 that is in communication with at least the converter circuit 120 of the electric drive 104. The converter circuit 120 also includes a series of transistors or gated switches 130, such as insulated-gate bipolar transistors, and associated diodes 132 for selectively enabling one or more phase windings of the respective stator 116 of the electric generator 106 and/or the electric motor 108. A three-phase switched reluctance machine, for example, may be provided with two switches 130, such as a first switch 130-1 and a second switch 130-2, and two diodes 132 for selectively enabling or disabling each of the three phase legs. Each switch 130 may be individually enabled or disabled via gate signals supplied by the controller 128.

As also shown in FIGS. 2 and 3, one or more sensors 134 may also be provided to generate a sensor signal corresponding to the angular position, displacement and/or speed of the rotor 114 relative to the stator 116, and communicate the sensor signal to an input of the controller 128. The sensors 134 may include encoders, Hall-effect sensors, variable reluctance sensors, anisotropic magnetoresistance sensors, or the like. Additionally, the control system 126 and the converter circuit 120 may be powered by an external or secondary power source, such as provided by a battery (not shown), residual voltage stored in a capacitor or ultracapacitor 136 of the common bus 118, or any other suitable current limited DC power supply.

The controller 128 in FIGS. 2 and 3 may be implemented using one or more of a processor, a microprocessor, a microcontroller, an electronic control module (ECM), an electronic control unit (ECU), and any other suitable means for providing electronic control to the electric generator 106 and/or the electric motor 108. The controller 128 may be configured to operate according to predetermined algorithms or sets of instructions designed to optimize performance based on observed characteristics of the electric drive 102. For example, the controller 128 can determine an optimal mode of operation for a given combination of observed operating speed, load characteristics and/or phase current requirements. Based on these parameters, the controller 128 may adjust the phase current supplied to each phase leg of the electric generator 106 or the electric motor 108, and operate according to any one of a single pulse mode, a current regulation mode, and the like. Additionally, the controller 128 may be configured to refer to predefined control maps or lookup tables which suggest the control scheme or routine most suited for a given situation. Such algorithms or sets of instructions for operating the electric generator 106 or the electric motor 108 may be preprogrammed or incorporated into a memory associated with the controller 128 by means commonly known in the art.

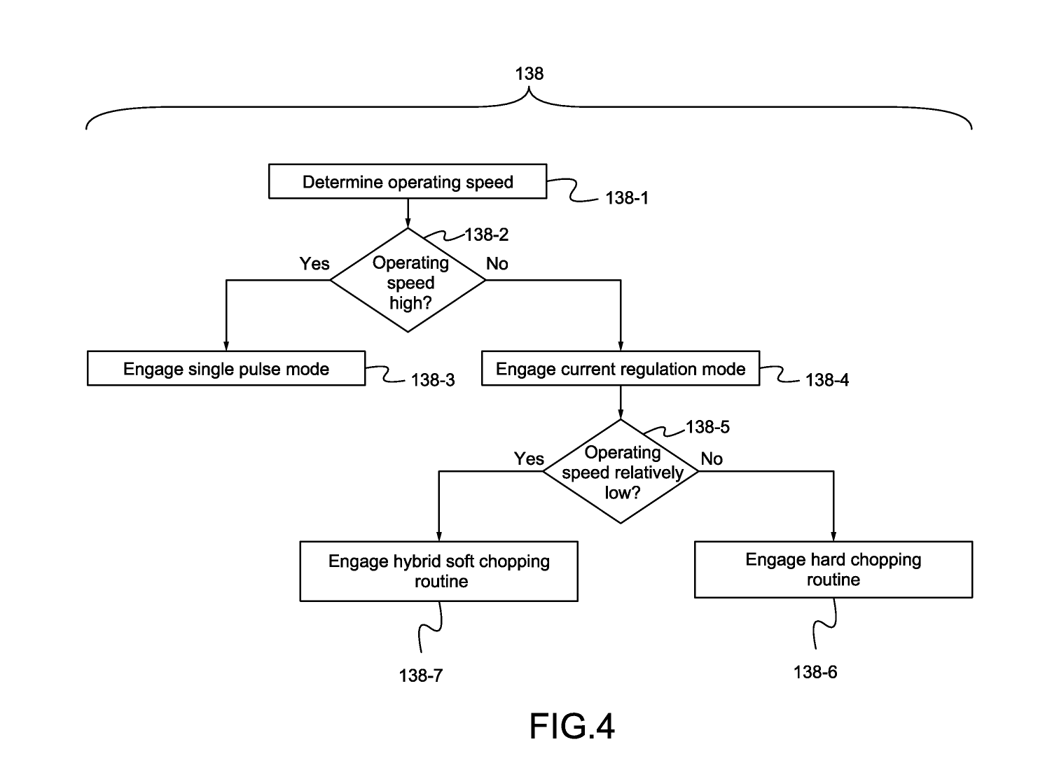

Referring now to FIG. 4, a flow diagram of an exemplary algorithm or method 138 by which the controller 128 may be configured to operate an electric generator 106 or an electric motor 108 is provided. In block 138-1, the controller 128 is configured to determine the operating speed of the electric generator 106 or the electric motor 108, and in block 138-2, the controller 128 compares the observed operating speed with one or more predefined thresholds or ranges of thresholds to determine if the operating speed is relatively high, nominal, or relatively low, as compared to a base speed. While the base speed for any particular application may vary, the base speed can be generally defined as the maximum speed at which the electric generator 106 or the electric motor 108 is able to output constant torque and before torque output begins to decrease proportionally with operating speed. Relatively low operating speeds may refer to speeds between zero and the approximate base speed, while relatively high operating speeds may refer to speeds exceeding the approximate base speed. Nominal operating speeds may refer to a range of speeds which approximate the base speed.

As shown in FIG. 4, if the operating speed is observed to be relatively high in block 138-2, the controller 128 may be configured to engage a single pulse mode of operation in block 138-3. During a single pulse mode of operation, the controller 128 may transmit gate signals configured to continuously enable or close both of the switches 130 of the converter circuit 120 associated with each phase leg of the respective stator 116 in a manner which sustains a substantially constant power range of output. Alternatively, if the controller 128 in block 138-2 determines that the operating speed is indicative of nominal speeds or relatively low speeds, the controller 128 may be configured to engage a current regulation mode of operating the electric generator 106 or the electric motor 108 according to block 138-4. Moreover, the controller 128 in block 138-5 may further distinguish between operating speeds that are nominal and relatively low, to determine whether to apply a hard chopping routine as in block 138-6 or a hybrid soft chopping routine as in block 138-7.

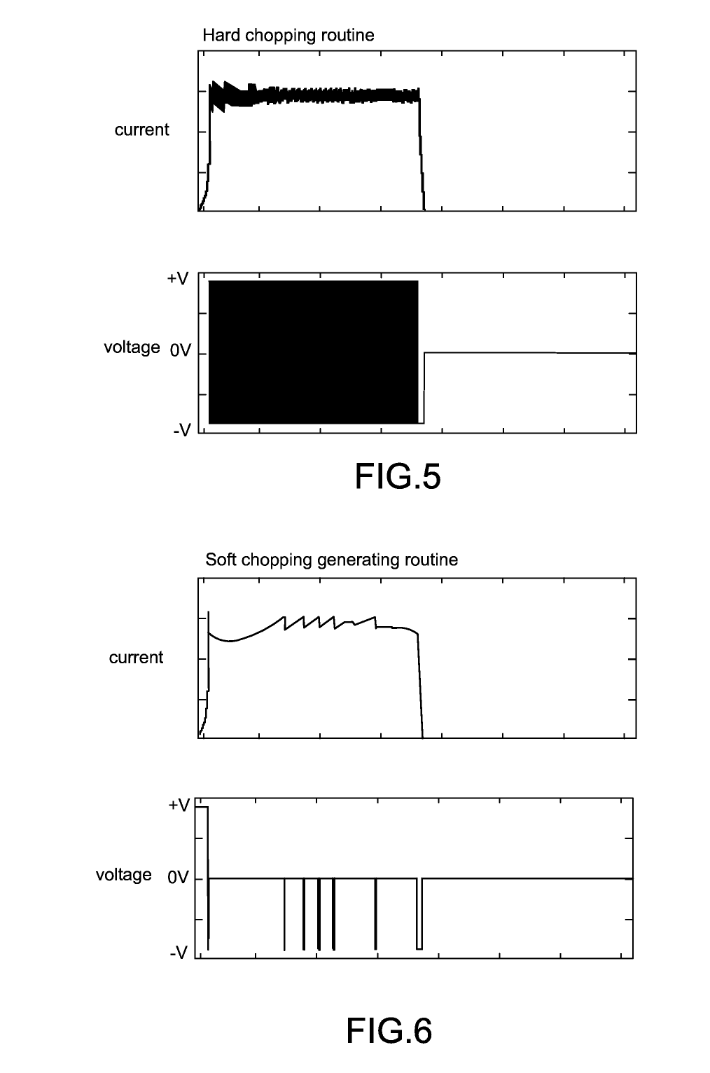

A hard chopping routine may generally not be applicable to the electric motor 108 of FIG. 3 due to the relatively low speeds with which the electric motor 108 would operate while in a generating mode. With respect to the electric generator 106 of FIG. 2, however, the controller 128 may engage a hard chopping routine in block 138-6 if the observed operating speed is nominal. While engaging the hard chopping routine, the controller 128 pulses current through each phase leg of the electric generator 106 by simultaneously switching, such as opening or closing, both of the first switch 130-1 and the second switch 130-2 of each phase. As shown for example in FIG. 5, hard chopping may provide relatively constant average phase current. However, as also shown in FIG. 5, hard chopping involves switching the bus voltage between −V and +V at relatively high switching frequencies, which can exert significant stress on the converter circuit 120 if used for prolonged periods of time.

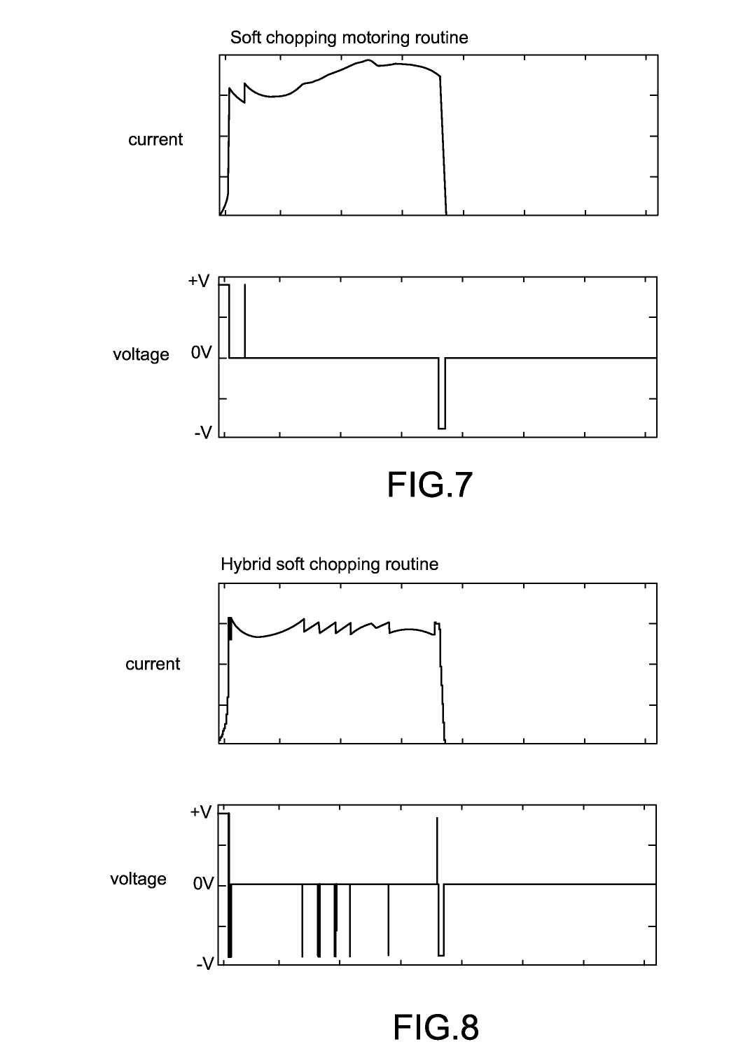

If the operating speed of the electric generator 106 or the electric motor 108 is relatively low, the controller 128 may be configured to engage a hybrid soft chopping routine as in block 138-7. In general, the controller 128 in block 138-7 engages soft chopping by transmitting gate signals which hold a first switch 130-1 of a given phase leg in either the opened or the closed state while switching the second switch 130-2 between opened and closed states. Furthermore, the controller 128 may be configured to engage a hybrid soft chopping routine, for example, selectively engaging the switches 130 according to a combination of a soft chopping generating routine as shown in FIG. 6 and a soft chopping motoring routine as shown in FIG. 7. Specifically, in a soft chopping generating routine, the controller 128 holds the first switch 130-1 in the opened state while switching the second switch 130-2, thereby pulsing the bus voltage between −V and 0V. In a soft chopping motoring routine, the controller 128 holds the first switch 130-1 in the closed state while switching the second switch 130-2, thereby pulsing the bus voltage between +V and 0V. In alternative embodiments, the second switch 130-2 may be held in either the opened or the closed state while the first switch 130-1 is selectively switched.

During the current regulation mode of block 138-4 of FIG. 4, the controller 128 may monitor the operating speed, the phase current, and/or any other relevant parameter to determine when to apply the soft chopping generating routine or the soft chopping motoring routine. In general, the controller 128 monitors the phase current relative to two or more predefined hysteresis bands to determine whether to apply the soft chopping generating routine or the soft chopping motoring routine. For example, if the phase current falls below predefined lower limits while engaging the soft chopping generating routine, the controller 128 engages the soft chopping motoring routine to increase the average phase current. Correspondingly, if the phase current rises above predefined upper limits while engaging the soft chopping motoring routine, the controller 128 engages the soft chopping generating routine to decrease the average phase current. The resulting phase current and bus voltage in FIG. 8 illustrates one example of regulating phase current based on a hybrid soft chopping routine.

Furthermore, one or more of the limits of each hysteresis band may be configured as current-based limits, time-based limits, or based on any other parameter capable of triggering a response by the controller 128. Current-based limits may include phase current limits that are defined based on specified current values, specified current errors or differentials, or the like. For example, a current-based limit may be triggered if the phase current reaches a specified current value or deviates from the desired value by a specified current differential. Time-based limits may include phase current limits that are defined based on a set duration or timed value. For example, a time-based limit may be triggered if appropriate correction of the phase current does not occur within a specified timeframe, where the timer automatically begins when the phase current departs from a first set of limits or hysteresis band, or the like.

Other variations and modifications will be apparent to those of ordinary skill in the art. Exemplary algorithms or methods by which the controller 128 may be operated to regulate current in a switched reluctance machine is discussed in more detail below.

### INDUSTRIAL APPLICABILITY

In general, the present disclosure finds utility in various industrial applications, such as construction, mining and farming industries. Specifically, the disclosed systems and methods provide current regulation control schemes for electric generators and electric motors, such as switched reluctance machines, which are commonly used in association with work machines and/or vehicles, such as tractors, backhoe loaders, compactors, feller bunchers, forest machines, industrial loaders, skid steer loaders, wheel loaders, and the like. Moreover, by providing more versatile combinations of soft chopping routines, the present disclosure enables more consistent phase currents at low operating speeds. Furthermore, by enabling more reliable performance at lower switching frequencies, the present disclosure helps to exert less stress on the converter circuit and promote the overall health of the electric drive.

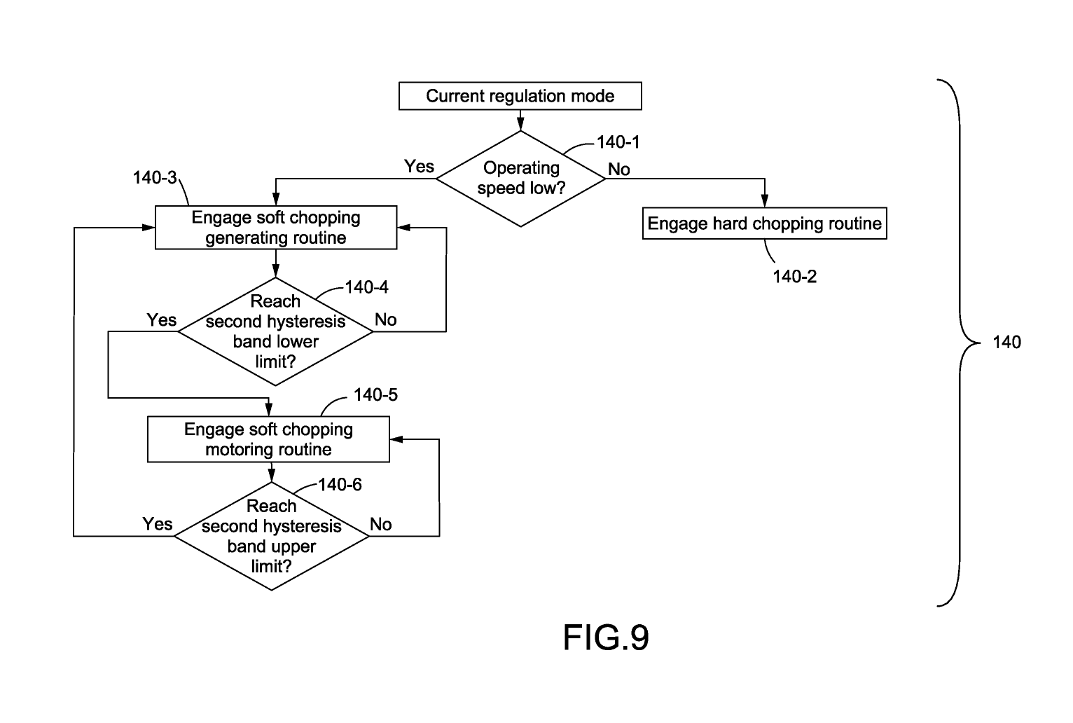

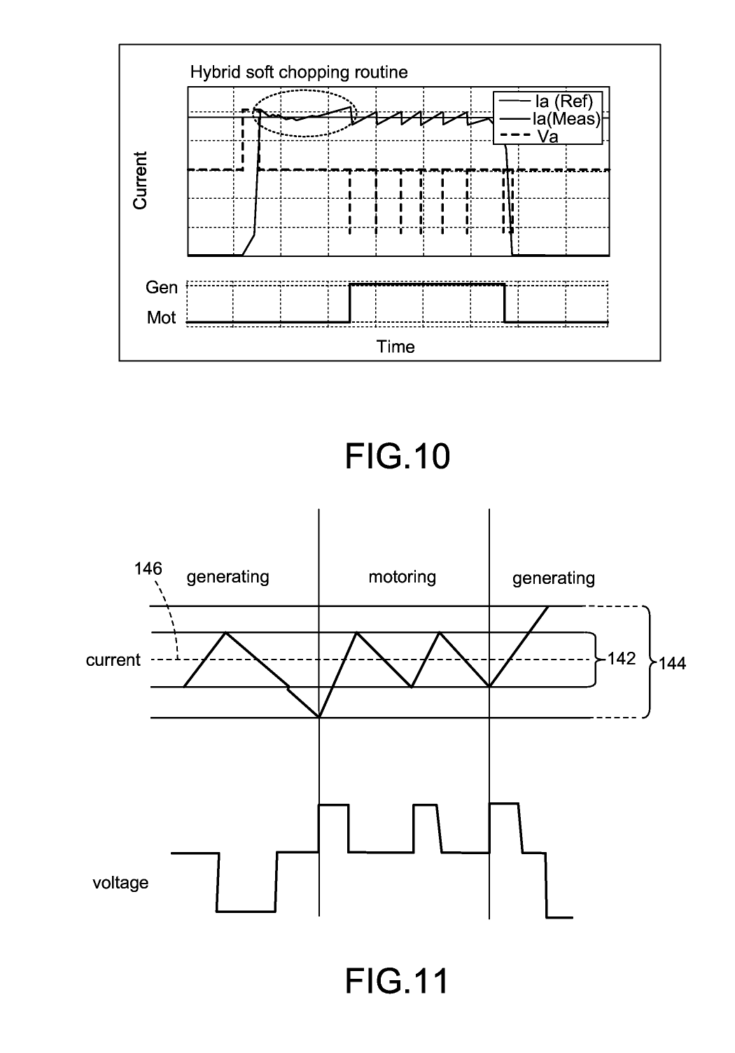

Turning now to FIG. 9, one exemplary algorithm or controller-implemented method 140 of regulating phase current of an electric generator 106 or an electric motor 108, such as a switched reluctance machine, is diagrammatically provided. As shown, the controller 128 according to block 140-1 may be configured to monitor the operating speed to determine whether to apply a hard chopping routine or a hybrid soft chopping routine. For example, if the operating speed is nominal, the controller 128 may engage a hard chopping routine according to block 140-2, or by simultaneously opening and closing both of the first switch 130-1 and the second switch 130-2 of each phase until the average target phase current is achieved. If the operating speed is relatively low, the controller 128 may proceed to engage a hybrid soft chopping routine, or a combination of a soft chopping generating routine and a soft chopping motoring routine as graphically illustrated for example in FIG. 10. It will be understood that current regulation modes for electric motors 108 configured as shown for example in FIG. 3 may not employ hard chopping routines since regenerative braking and other generating modes for operating such an electric motor 108 will tend to be limited to relatively low operating speeds.

According to block 140-3 of FIG. 9, the controller 128 may be configured to engage the soft chopping generating routine, such as by holding a first switch 130-1 of each phase in the opened state while switching the second switch 130-2 between the opened and closed states. As further illustrated in FIG. 11, the controller 128 selectively engages the second switch 130-2, and thereby pulses the bus voltage between −V and 0V to maintain the phase current within acceptable limits. Specifically, the controller 128 may be configured to adjust the phase current according to both a first hysteresis band 142 and a second hysteresis band 144, each being centered about the target phase current 146 and having respective upper and lower limits. The first hysteresis band 142 may define the inner bounds of the phase current, or the limits at which the controller 128 may turn the second switch 130-2 on or off during either of the soft chopping generating routine or the soft chopping motoring routine. The second hysteresis band 144 may define the outer bounds of the phase current, or the limits at which the controller 128 may alternate between the soft chopping generating routine and the soft chopping motoring routine. Moreover, the second upper limit may be greater than the first upper limit and the second lower limit may be lower than the first lower limit. In alternative embodiments, the controller 128 may hold the second switch 130-2 in the opened state while switching the first switch 130-1.

In addition, one or more of the limits of the first hysteresis band 142 and the second hysteresis band 144 may be configured as current-based limits, time-based limits, or based on any other parameter capable of triggering a response by the controller 128. Current-based limits may include phase current limits that are defined based on specified current values, specified current errors or differentials, or the like. For example, a current-based limit may be triggered if the phase current reaches a specified current value or deviates from the desired value by a specified current differential. Time-based limits may include phase current limits that are defined based on a set duration or timed value. For example, a time-based limit may be triggered if appropriate correction of the phase current does not occur within a specified timeframe, where the timer automatically begins when the phase current departs from a first set of limits or hysteresis band, or the like.

Referring back to FIG. 9, the controller 128 in block 140-3 may engage the soft chopping generating routine according to the first hysteresis band 142 at least until the phase current exceeds, or falls below the lower limit of, the first hysteresis band 142. If the phase current falls below the lower limit of the first hysteresis band 142 as shown in FIG. 11, the controller 128 in block 140-4 may monitor for when the phase current reaches the lower limit of the second hysteresis band 144, which may represent a specified current value, a specified duration value, or the like. If the phase current is corrected prior to reaching the lower limit of the second hysteresis band 144, the controller 128 may continue engaging the soft chopping generating routine according to block 140-3. If, however, the phase current reaches the lower limit of the second hysteresis band 144 as shown in FIG. 10, the controller 128 engages a soft chopping motoring routine according to block 140-5. Specifically, the controller 128 holds the first switch 130-1 in each phase in the closed state while switching the second switch 130-2 between the opened and closed states, thereby pulsing the bus voltage between 0V and +V.

By engaging the soft chopping motoring routine, the controller 128 is able to counter the general drooping effect associated with the soft chopping generating routine and adjust the phase current back to within the limits of the first hysteresis band 142 as shown in FIG. 11. The controller 128 in block 140-5 may continue engaging the soft chopping motoring routine at least until the phase current exceeds, or rises above the upper limit of, the first hysteresis band 142. If the phase current exceeds the upper limit of the first hysteresis band 142 as shown in FIG. 11, the controller 128 in block 140-6 may monitor for when the phase current reaches the upper limit of the second hysteresis band 144, which may also represent a specified current value, a specified duration value, or the like. If the phase current is corrected prior to reaching the upper limit of the second hysteresis band 144, the controller 128 may continue engaging the soft chopping motoring routine according to block 140-5. If, however, the phase current reaches the upper limit of the second hysteresis band 144 as shown in FIG. 11, the controller 128 can alternate again and engage the soft chopping generating routine of block 140-3. Engaging the soft chopping generating routine aids in offsetting the general rising effect associated with the soft chopping motoring routine, and returns the phase current back to within the limits of the first hysteresis band 142 as shown in FIG. 11.

The controller 128 may continue employing the hybrid soft chopping routine, such as reiteratively alternating between the soft chopping generating routine and the soft chopping motoring routine, so long as the operating speed of the electric generator 106 or the electric motor 108 as determined in block 140-1 remains relatively low, and so long as the current regulation mode of operation is maintained. For example, if the operating speed reaches nominal speeds at any time, the controller 128 may cease the hybrid soft chopping routines and engage the hard chopping routine. Additionally, if the operating speed reaches relatively high speeds at any time, such as determined by block 138-2 of FIG. 4, the controller 128 may cease operating in the current regulation mode and engage a single pulse mode of operation as in block 138-3 of FIG. 4.

From the foregoing, it will be appreciated that while only certain embodiments have been set forth for the purposes of illustration, alternatives and modifications will be apparent from the above description to those skilled in the art. These and other alternatives are considered equivalents and within the spirit and scope of this disclosure and the appended claims.

What is claimed is:

1. A method of regulating a phase current of an electric motor, comprising:
selectively enabling one or more switches of each phase of the electric motor according to one of at least a soft chopping motoring routine and a soft chopping generating routine;
monitoring the phase current relative to a first hysteresis band;
controlling the switches according to the soft chopping motoring routine when the phase current exceeds the first hysteresis band while operating according to the soft chopping generating routine; and
controlling the switches according to the soft chopping generating routine when the phase current exceeds the first hysteresis band while operating according to the soft chopping motoring routine.

2. The method of claim 1, wherein the electric motor is a switched reluctance motor operating in a regenerative braking mode at relatively low speeds, the switches being selectively enabled according to one of the soft chopping motoring routine and the soft chopping generating routine.

3. The method of claim 2, wherein each phase of the electric motor includes a first switch and a second switch, the first switch being continuously enabled while the second switch is selectively enabled according to the soft chopping motoring routine, the first switch being continuously disabled while the second switch is selectively enabled according to the soft chopping generating routine.

4. The method of claim 1, wherein the first hysteresis band is centered about a target current and includes a first upper limit and a first lower limit, the switches being controlled according to the soft chopping motoring routine when the phase current falls below the first lower limit while operating according to the soft chopping generating routine, and the switches being controlled according to the soft chopping generating routine when the phase current rises above the first upper limit while operating according to the soft chopping motoring routine.

5. The method of claim 1, wherein the phase current is monitored relative to the first hysteresis band and a second hysteresis band, each of the first hysteresis band and the second hysteresis band being centered about a target current, the first hysteresis band having a first upper limit and a first lower limit, the second hysteresis band having a second upper limit and a second lower limit, the second upper limit being greater than the first upper limit, the second lower limit being less than the first lower limit.

6. The method of claim 5, wherein the switches are controlled according to the soft chopping motoring routine when the phase current falls below the first lower limit and reaches the second lower limit while operating according to the soft chopping generating routine, and the switches are controlled according to the soft chopping generating routine when the phase current rises above the first upper limit and reaches the second upper limit while operating according to the soft chopping motoring routine.

7. The method of claim 5, wherein one or more of the second upper limit and the second lower limit of the second hysteresis band are defined based on at least one of a current-based limit and a time-based limit.

8. A control system for regulating a phase current of an electric motor, comprising:
a converter circuit operatively coupled to a stator of the electric motor, the converter circuit including one or more switches coupled to each phase of the stator; and
a controller in communication with each of the electric motor and the converter circuit, the controller being configured to enable the switches of each phase of the stator according to one of at least a soft chopping motoring routine and a soft chopping generating routine, monitor the phase current relative to each of a first hysteresis band and a second hysteresis band, control the switches according to the soft chopping motoring routine when the phase current exceeds at least the first hysteresis band while operating according to the soft chopping generating routine, and control the switches according to the soft chopping generating routine when the phase current exceeds at least the first hysteresis band while operating according to the soft chopping motoring routine.

9. The control system of claim 8, wherein the electric motor is a switched reluctance motor operating in a regenerative braking mode at relatively low speeds.

10. The control system of claim 8, wherein the controller is configured to selectively enable the switches according to one of at least the soft chopping motoring routine and the soft chopping generating routine.

11. The control system of claim 10, wherein each phase of the stator includes a first switch and a second switch, the soft chopping motoring routine configuring the controller to continuously enable the first switch while selectively enabling the second switch, and the soft chopping generating routine configuring the controller to continuously disable the first switch while selectively enabling the second switch.

12. The control system of claim 8, wherein the controller is configured to define the first hysteresis band as being centered about a target current and having a first upper limit and a first lower limit, and define the second hysteresis band as also being centered about the target current and having a second upper limit that is greater than the first upper limit and a second lower limit that is less than the first lower limit, one or more of the second upper limit and the second lower limit of the second hysteresis band being defined based on at least one of a current-based limit and a time-based limit.

13. The control system of claim 12, wherein the controller is configured to control the switches according to the soft chopping motoring routine when the phase current falls below the first lower limit and reaches the second lower limit while operating according to the soft chopping generating routine, and control the switches according to the soft chopping generating routine when the phase current rises above the first upper limit and reaches the second upper limit while operating according to the soft chopping motoring routine.

14. An electric drive, comprising:
an electric motor having a rotor and a stator and a plurality of phases;
a converter circuit in communication with the electric motor, the converter circuit including at least a first switch and a second switch coupled to each phase; and
a controller in communication with each of the electric motor and the converter circuit, the controller configured to monitor the phase current relative to a first hysteresis band, control the first switch and the second switch according to the soft chopping motoring routine when the phase current exceeds the first hysteresis band while operating according to the soft chopping generating routine, and control the first switch and the second switch according to the soft chopping generating routine when the phase current exceeds the first hysteresis band while operating according to the soft chopping motoring routine.

15. The electric drive of claim 14, wherein the electric motor is a switched reluctance motor operating in a regenerative braking mode at relatively low speeds.

16. The electric drive of claim 14, wherein the controller is configured to selectively enable the first switch and the second switch according to one of at least the soft chopping motoring routine and the soft chopping generating routine.

17. The electric drive of claim 16, wherein the soft chopping motoring routine configures the controller to continuously enable the first switch while selectively enabling the second switch, and the soft chopping generating routine configures the controller to continuously disable the first switch while selectively enabling the second switch.

18. The electric drive of claim 14, wherein the controller is configured to define the first hysteresis band as being centered about a target current and including a first upper limit and a first lower limit, the controller being configured to control the first switch and the second switch according to the soft chopping motoring routine when the phase current falls below the first lower limit while operating according to the soft chopping generating routine, and control the first switch and the second switch according to the soft chopping generating routine when the phase current rises above the first upper limit while operating according to the soft chopping motoring routine.

19. The electric drive of claim 14, wherein the controller is configured to monitor the phase current relative to the first hysteresis band and a second hysteresis band, the controller being configured to define the first hysteresis band as being centered about a target current and having a first upper limit and a first lower limit, and define the second hysteresis band as also being centered about the target current and having a second upper limit that is greater than the first upper limit and a second lower limit that is less than the first lower limit, one or more of the second upper limit and the second lower limit of the second hysteresis band being defined based on at least one of a current-based limit and a time-based limit.

20. The electric drive of claim 19, wherein the controller is configured to control the first switch and the second switch according to the soft chopping motoring routine when the phase current falls below the first lower limit and reaches the second lower limit while operating according to the soft chopping generating routine, and control the first switch and the second switch according to the soft chopping generating routine when the phase current rises above the first upper limit and reaches the second upper limit while operating according to the soft chopping motoring routine.
